(19) United States
(12) Patent Application Publication
(10) Pub. No.: US 2016/0288142 A1
(43) Pub. Date: Oct. 6, 2016

(54) SHOWER APPARATUS AND METHOD

(71) Applicant: Corey Barnett Johnson, Hyrum, UT (US)

(72) Inventor: Corey Barnett Johnson, Hyrum, UT (US)

(21) Appl. No.: 14/673,749

(22) Filed: Mar. 30, 2015

(51) Int. Cl. B05B 1/18; A47K 3/40

(52) U.S. Cl. CPC B05B 1/185; A47K 3/40

(57) ABSTRACT

A shower apparatus includes a plurality of controllable shower heads, shower jets, or a combination thereof. The controllable shower heads are configured to be moveable while showering. In an exemplary embodiment a plurality of controllable shower heads are positioned above a shower bed. The shower heads are controllable through user input to a control panel. The shower apparatus also includes a holding tank and recirculation system to allow for extended showering. A method for operating a showering apparatus is also provided.

### BACKGROUND

Traditional shower apparatus use traditional shower heads and traditional shower enclosures. Traditional shower enclosures and shower fixtures are configured vertically. A standard shower enclosure, for example, is tall enough to accommodate an adult in a standing position. A basic shower typically provides a shower head mounted on a wall of the shower enclosure at a height above many adults and a device for controlling water flow and temperature. A standard wall mounted shower head is typically permanently located. Some shower heads may be repositioned along the mounting wall but once repositioned are configured to be fixed in that new position. Shower heads typically have some limited ability to adjust the angle at which water flowing from the shower head impacts the user. Shower heads may also have some limited ability to adjust the intensity of the water flow from the shower head. Often the user will move around under the water flowing from the shower head both to increase the area of impact and to decrease the time a single area of the body is impacted. Numerous users find that allowing water flowing from the shower head to impact the same surface area of the body for an extended time becomes uncomfortable. Many users also find that they are unable to comfortably stand as long as they would like to enjoy showering. Further, a number of users have concerns about excessive use of water during extended showering.

### BRIEF DESCRIPTION OF THE DRAWINGS

The accompanying drawings illustrate various examples of the exemplary embodiments described herein and are a part of the specification. The illustrated exemplary embodiments are merely examples and do not limit the scope of the claims.

FIG. 1 is a perspective view of a shower apparatus that includes a plurality of controllable shower heads according to an exemplary embodiment described herein.

FIG. 2 is a perspective view of an upper shower deck arrangement of a like embodiment as illustrated in FIG. 1 illustrating movement of the controllable shower heads, according to an exemplary embodiment described herein.

FIG. 3 is a perspective view of an alternate upper shower deck arrangement, according to an exemplary embodiment described herein.

FIG. 4 is a diagram of a holding tank arrangement, according to an exemplary embodiment described herein.

FIG. 5 is a diagram of an alternate holding tank arrangement according to an exemplary embodiment described herein.

FIG. 6 is a perspective view of an alternate shower apparatus according to an exemplary embodiment described herein.

FIG. 7 is a perspective view of an alternate shower apparatus according to an exemplary embodiment described herein.

FIG. 8 is a side view of an alternate shower apparatus according to an exemplary embodiment described herein.

FIG. 9 is a top view of an alternate shower apparatus according to an exemplary embodiment described herein.

Throughout the drawings, identical reference numbers designate similar, but not necessarily identical, elements.

### DETAILED DESCRIPTION

Throughout this description and in the accompanying drawings reference is made to principles of the invention through the use of exemplary embodiments. It should be understood that the application is not limited to the details or specific methodologies set forth herein. It should also be understood that the terminology used herein is for the purpose of description only and should not be regarded as limiting.

In the following description, for purposes of explanation, numerous specific details are set forth in order to provide a thorough understanding of the present systems and methods. It will be apparent, however, to one skilled in the art that the present apparatus, systems and methods may be practiced without these specific details. Reference in the specification to “an example” or similar language means that a particular feature, structure, or characteristic described in connection with the example is included in at least that one example, but not necessarily in other examples.

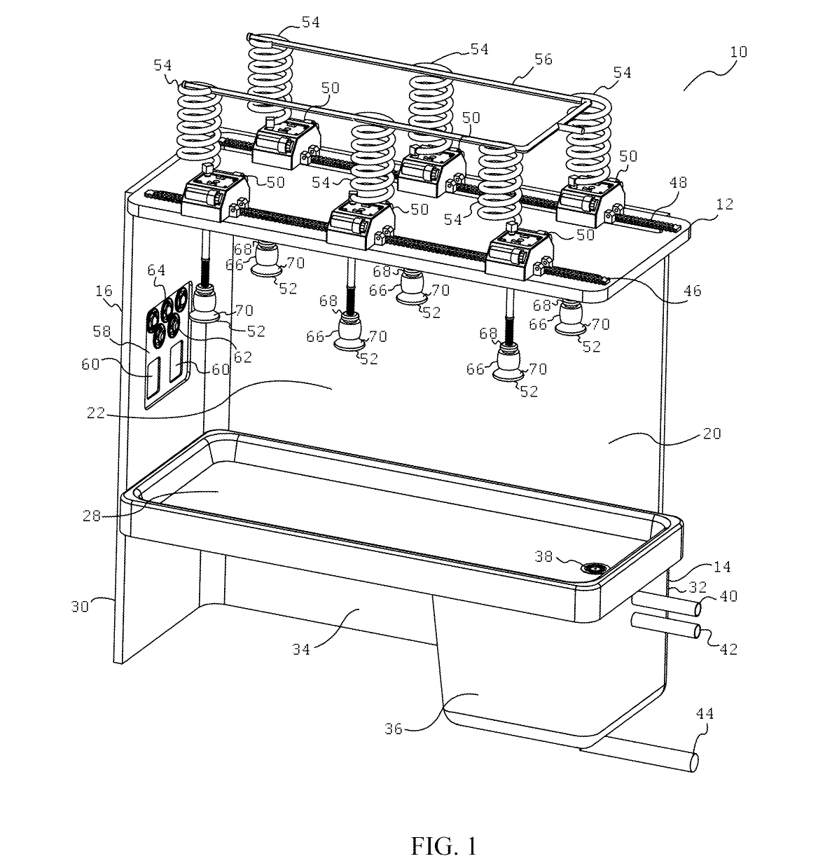

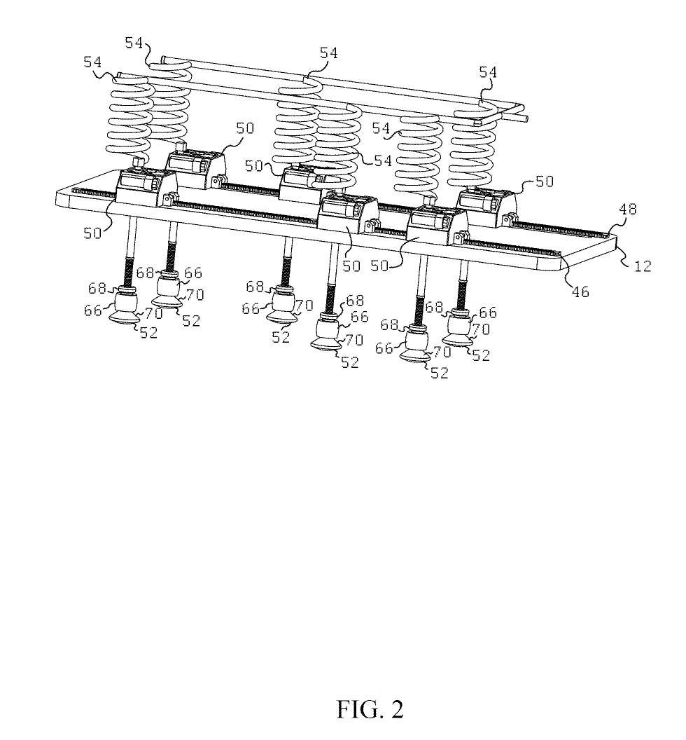

Referring initially to FIGS. 1 and 2, an exemplary embodiment of the overall shower apparatus taught by the invention provides a recumbent shower apparatus 10 which includes a shower head deck 12 and a shower drain deck 14. Between shower head deck 12 and shower drain deck 14 are positioned a first enclosure side wall 16, a second enclosure side wall (not shown), and a rear enclosure wall 20.

First enclosure side wall 16, second enclosure side wall (not shown) opposite first enclosure side wall 16, and rear enclosure wall 20 together form a recumbent shower enclosure 22 above shower drain deck 14 and below shower head deck 12. Recumbent shower enclosure 22 is designed to allow a user to enjoy an extended shower in a reclining position rather than in a standing or vertical position. It should be understood that recumbent shower enclosure 22 may not fully surround the shower area.

Shower drain deck 14 includes a bed portion 28, a first support wall 30, a second support wall 32, a rear support wall 34, and a holding tank arrangement 36. Bed portion 28 includes drain 38 which allows water collected on bed portion 28 to drain into holding tank 36.

Input pipe 40 is configured to allow flow of hot and cold water into holding tank 36. A pump (not shown) pumps water from the holding tank to the shower head deck 12 and throughout the system. Cleansing solution port 42 is configured to allow injection of a cleansing solution into holding tank 36. Output pipe 44 is configured to route water from the holding tank 36 to a heater (not shown) which heats the water as needed to maintain the preferred temperature of the water as set by the user.

Shower head deck 12 includes a first guide rail 46 and a second guide rail 48. Moveably positioned on guide rails 46,48 are shower head conveyor robots 50. Shower heads 52 are attached to shower head conveyor robots 50. Shower heads 52 may include spray patterns, oscillators, jets or other water delivery devices or combinations of water delivery devices. Coils 54 provide water through shower head input pipe 56 to shower heads 52 and power to shower head conveyor robots 50. Shower head conveyor robots 50 move along guide rails 46,48.

In this example guide rails 46,48 are shown parallel and of equal length with equal numbers of shower head conveyor robots, shower heads, and coils however the shower head deck may have any number of shower head conveyor robots, shower heads and coils in a variety of other configurations.

Shower head conveyor robots are controllable by the user through control panel 58 located on first enclosure side wall 16. Control panel 58 includes user controls 60, speakers 62, and air vents 64. User controls 60 may, for example, be a push button device, a touch sensitive touchscreen device, a voice activated device, or other control device or combination of control devices designed to operate in a moist environment. In this example user controls, speakers and air vents are incorporated into the control panel however these elements may be positioned independently, in a variety of configurations, and in a variety of locations.

Shower heads 52 include a shower head oscillator 66, a shower head flow control valve 68, and a shower head spray portion 70. Shower head oscillator 66 allows for movement of shower head spray portion 70. Shower head spray portion 70 may allow for adjustment of spray patterns, spray strength and spray duration.

Using controls 60 a user may program shower head conveyor robots 50 to move in a desired pattern, shower heads 52 to oscillate as desired, and adjust the shower head spray portion 70 as desired. Controls 60 may also be used to adjust speakers 62 for listening to music or other entertainment and air vents 64 to provide desired air circulation, if any. In this example user controls are directed to shower conveyor robots, shower heads, speakers and air vents however some of these may be excluded or other user controllable elements may be included to provide an optimal user experience.

Referring to FIG. 2, shower head conveyor robots 50 are shown in varying positions along guide rails 46,48. Through controls 60, a user may program shower head conveyor robots 50 to move shower heads 52 to a variety of locations along guide rails 46,48 and in a variety of movement patterns in accordance with the users preference.

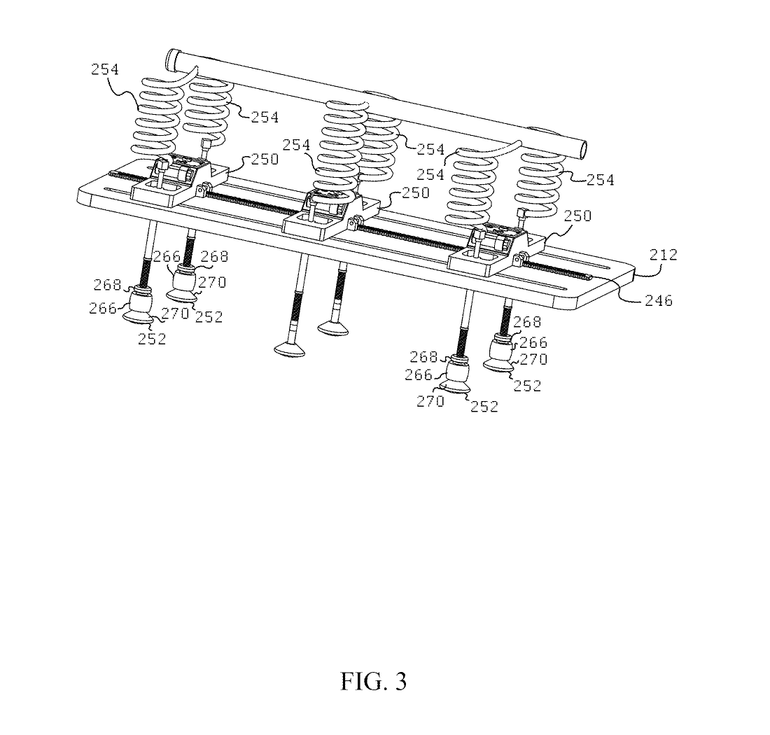

Referring to FIG. 3, an alternate shower head deck 212 includes shower head conveyor robots 250 for moving shower heads 252 along guide rail 246. In this example, shower head conveyor robots 250 move shower heads 252 in pairs.

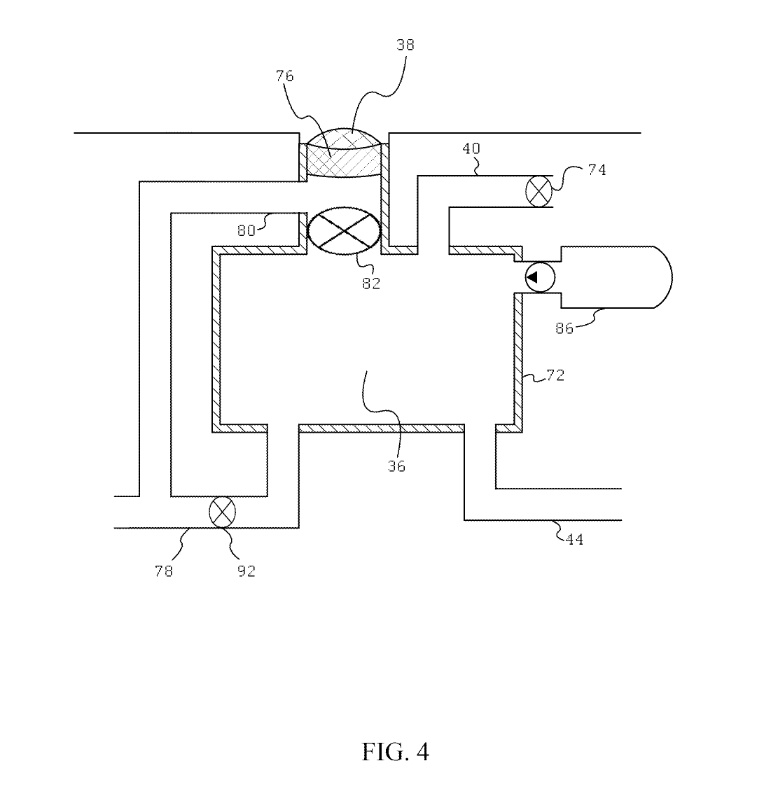

Referring to FIG. 4, holding tank arrangement 36 includes water tank 72 which may receive water through input pipe 40 during filling. Upon completion of a shower session a cleansing cycle is performed with water and treatment solution being drained through upper drain pipe 80 which is located outside water tank 72.

Fresh water valve 74 is open allowing hot and cold water to flow into water tank 72. After filling water tank 72, fresh water valve 74 is closed and water is recirculated through the system. Water flows out through shower heads (not shown) and flows back into water tank 72 through drain 38. Water received through drain 38 is filtered through filter 76 before entering water tank 72 to reduce or eliminate foreign material entering the holding tank arrangement. Water tank 72 may output water to the pump (not shown) and heater (not shown) through output pipe 44 during use for showering.

When the system is shut down main waste water valve 92 is opened. The water tank 72 is then drained through lower drain pipe 78. Once water tank 72 is drained, waste water valve 92 is closed and the tank is filled or partially filled with fresh water. During this time, cleansing pump, 86, injects a measured amount of chlorine or other cleansing chemicals or solutions into water tank 72. Next, the bed drain valve 82 is closed and pump (not shown) is turned on. A cleansing solution is then pumped throughout the system, which ultimately drains through drain 38, filter 76 and upper drain pipe 80. When water tank 72 is empty, bed drain valve 82 and waste water valve 92 open. This completes the cleaning cycle.

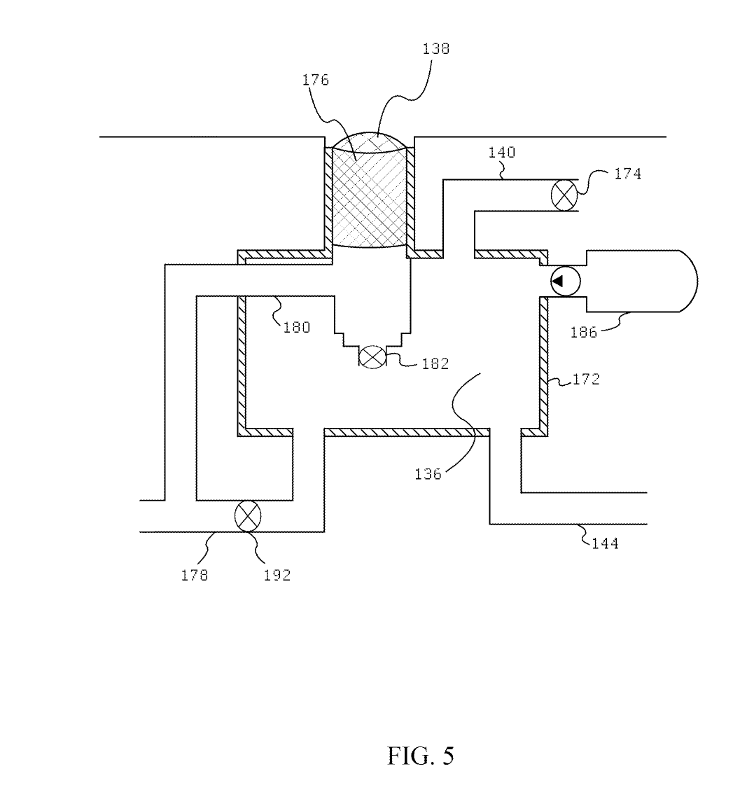

Referring to FIG. 5, an alternate holding tank arrangement 136 includes water tank 172 which may receive water through input pipe 140 during filling. Upon completion of a shower session a cleansing cycle is performed with water and treatment solution being drained through upper drain pipe 180 which is located inside water tank 172.

Fresh water valve 174 is open allowing hot and cold water to flow into water tank 172. After filling water tank 172, fresh water valve 174 is closed and water is recirculated through the system. Water flows out through shower heads (not shown) and flows back into water tank 172 through drain 138. Water received through drain 138 is filtered through filter 176 before entering water tank 172 to reduce or eliminate foreign material entering the holding tank arrangement. Water tank 172 may output water to the pump (not shown) and heater (not shown) through output pipe 144 during use for showering.

When the system is shut down main waste water valve 192 is opened. The water tank 172 is then drained through lower drain pipe 178. Once water tank 172 is drained, waste water valve 192 is closed and the tank is filled or partially filled with fresh water. During this time, cleansing pump, 186, injects a measured amount of chlorine or other cleansing chemicals or solutions into water tank 172. Next, the bed drain valve 182 is closed and pump (not shown) is turned on. A cleansing solution is then pumped throughout the system, which ultimately drains through drain 138, filter 176 and upper drain pipe 180. When water tank 172 is empty, bed drain valve 182 and waste water valve 192 open. This completes the cleaning cycle.

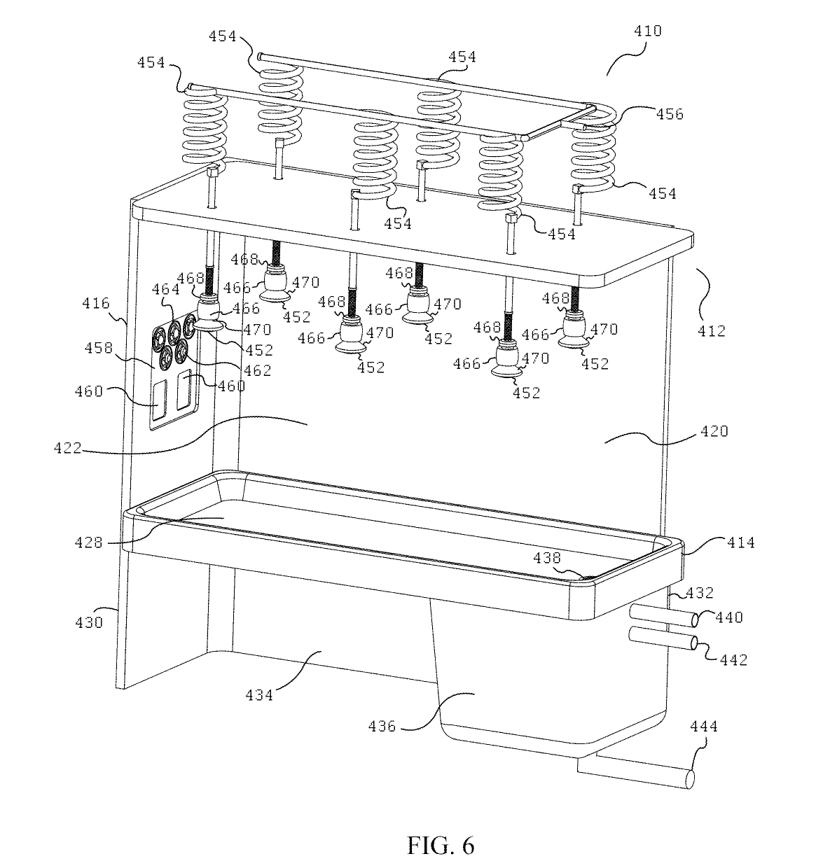

Referring to FIG. 6, an alternate exemplary embodiment of the overall shower apparatus taught by the invention provides a recumbent shower apparatus 410 which includes a shower head deck 412 and a shower drain deck 414. Between shower head deck 412 and shower drain deck 414 are positioned a first enclosure side wall 416, a second enclosure side wall (not shown), and a rear enclosure wall 420.

First enclosure side wall 416, second enclosure side wall 418, and rear enclosure wall 420 together form a recumbent shower enclosure 422 above shower drain deck 414 and below shower head deck 412. Recumbent shower enclosure 422 is designed to allow a user to enjoy an extended shower in a reclining position rather than in a standing or vertical position. It should be understood that recumbent shower enclosure 422 may not fully surround the shower area.

Shower drain deck 414 includes a bed portion 428, a first support wall 430, a second support wall 432, a rear support wall 434, and a holding tank arrangement 436. Bed portion 428 includes drain 438 which allows water collected on bed portion 428 to drain into holding tank 436.

Input pipe 440 is configured to allow flow of hot and cold water into holding tank 436. Cleansing solution port 442 is configured to allow injection of a cleansing solution into holding tank 436. Output pipe 444 is configured to route water from the holding tank 436 to a heater (not shown) which heats the water as needed to maintain the preferred temperature of the water as set by the user. A pump (not shown) then pumps the water back to the shower head deck 412.

Shower head deck 412 includes shower heads 452. Coils 454 provide water through shower head input pipe 456 to shower heads 452. In this example coils are shown attached to input pipe 456 however individual input pipes, a water supply hub, or a variety of other known hardware configurations may be used to supply water to shower heads 452.

Shower heads 452 may be controllable by the user through control panel 458 located on first enclosure side wall 416. Control panel 458 includes user controls 460, speakers 462, and air vents 464. User controls 460 may be a voice controlled device, a touch sensitive touchscreen device, a push button device, or other control device or combination of control devices designed to operate in a moist environment. In this example user controls, speakers and air vents are incorporated into the control panel however these elements may be positioned independently, in a variety of configurations, and in a variety of locations.

Shower heads 452 include a shower head oscillator 466, a shower head flow control valve 468, and a shower head spray portion 470. Shower head oscillator 466 allows for movement of shower head spray portion 470. Shower head spray portion 470 may allow for adjustment of spray patterns, spray strength and spray duration.

Using controls 460 a user may program shower heads 452 to oscillate as desired, and adjust the shower head spray portion 470 as desired. Controls 460 may also be used to adjust speakers 462 for listening to music or other entertainment and air vents 464 to provide desired air circulation, if any. In this example user controls are directed to shower heads, speakers and air vents however some of these may be excluded or other user controllable elements may be included to provide an optimal user experience.

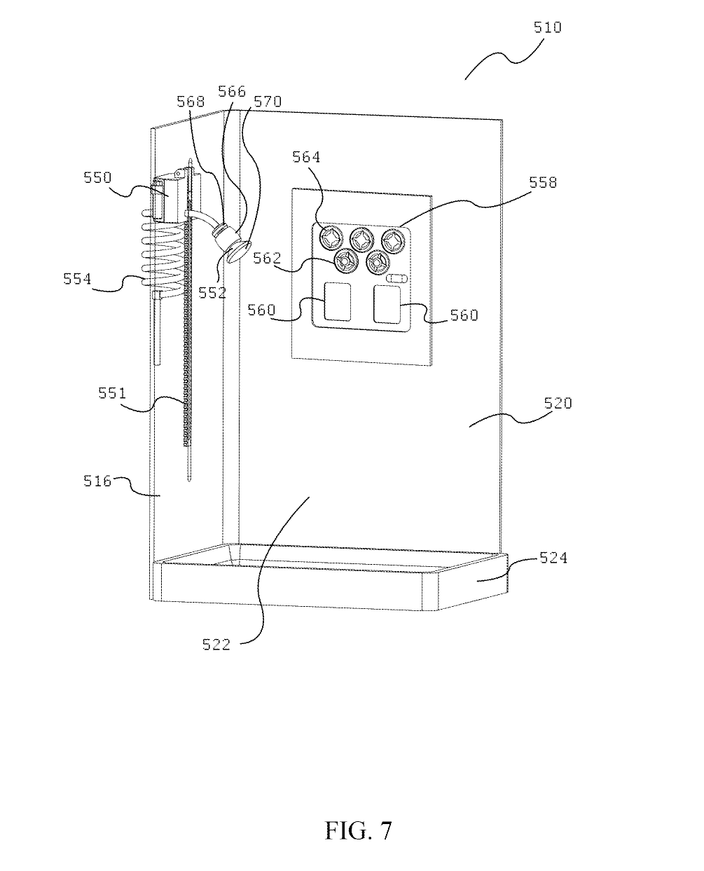

Referring to FIG. 7, an alternate exemplary embodiment of the overall shower apparatus taught by the invention provides a shower apparatus 510 which includes a shower drain deck 524, a first enclosure side wall 516, and a rear enclosure wall 520.

First enclosure side wall 516 and rear enclosure wall 520 together form a shower enclosure 522 above shower drain deck 524. Shower enclosure 522 is designed to allow a user to enjoy a shower in a standing or vertical position. It should be understood that shower enclosure 522 may not fully surround the shower area.

Shower head 552 is moveably mounted on first enclosure side wall 516. Moveably positioned on guide rail 551 is shower head conveyor robot 550. Shower heads 552 are attached to shower head conveyor robot 550. Coils 554 provide water through shower head input pipe (not shown) to shower head 552 and power to shower head conveyor robot 550. Shower head conveyor robots 550 move along guide rail 551. In this example a single controllable shower head 552, robot 550, and guide rail 551 are shown however any number of shower head conveyor robots, shower heads and coils may be included in a variety of other configurations.

Shower head conveyor robots are controllable by the user through control panel 558 located on rear enclosure wall 520. Control panel 558 includes user controls 560, speakers 562, and air vents 564. User controls 560 may be may be a touch sensitive touchscreen device designed to operate in a moist environment. In this example user controls, speakers and air vents are incorporated into the control panel however these elements may be positioned independently, in a variety of configurations, and in a variety of locations.

Shower heads 552 include a shower head oscillator 566, a shower head flow control valve 568, and a shower head spray portion 570. Shower head oscillator 566 allows for movement of shower head spray portion 570. Shower head spray portion 570 may allow for adjustment of spray patterns, spray strength and spray duration.

Using controls 560 a user may program shower head conveyor robots 550 to move in a desired pattern, shower heads 552 to oscillate as desired, and adjust the shower head spray portion 570 as desired. Controls 560 may also be used to adjust speakers 562 for listening to music or other entertainment and air vents 564 to provide desired air circulation, if any. In this example user controls are directed to shower conveyor robots, shower heads, speakers and air vents however some of these may be excluded or other user controllable elements may be included to provide an optimal user experience.

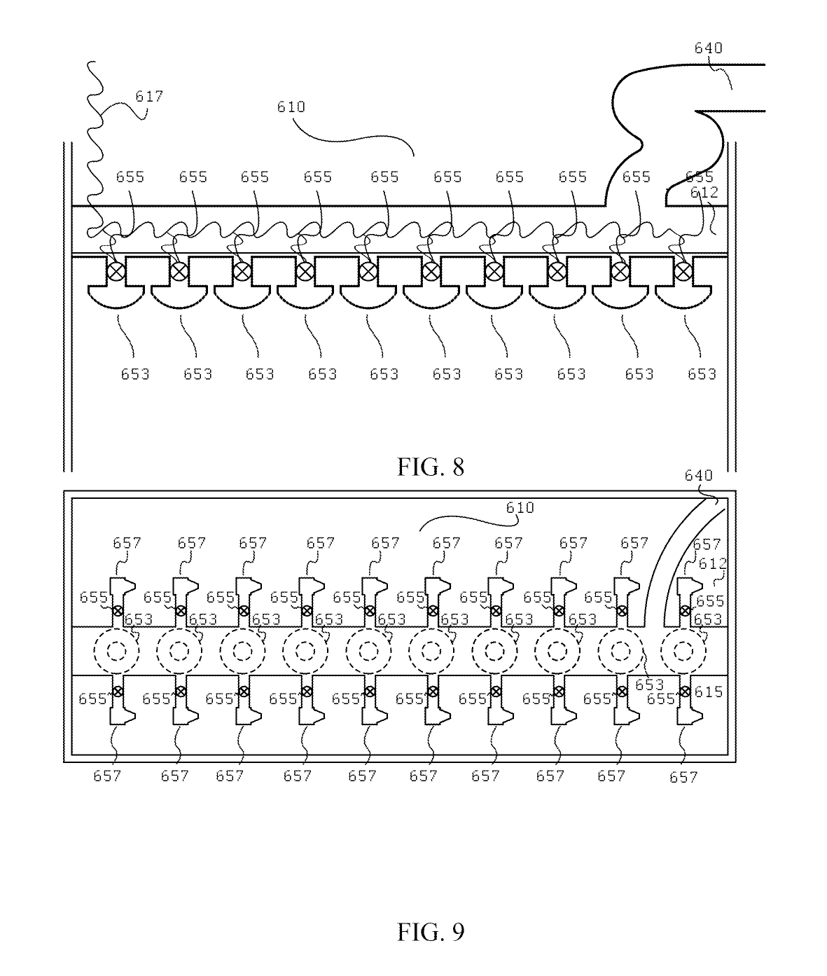

Referring to FIGS. 8 and 9, an alternate shower head apparatus 610 includes water line 612, power line 617, and water input 640. Water input 640 supplies water through water line 612 to a plurality of water delivery devices shown here as an array of shower heads 653 and shower jets 657. Shower heads 653 and shower jets 657 are controlled through activation of valves 655.

Using pre-programmed or user controlled programs valves 655 release water through shower heads 653 and/or shower jets 657. Shower heads 653 and shower jets 657 may all be on or off at once. Shower heads 653 and shower jets 657 may be on and off in sequences. Shower heads 653 may include spray patterns, oscillators, jets or other water delivery devices or combinations of water delivery devices.

By turning valves 655 on and off pulses of water are delivered through heads 653 and/or jets 657 which can be programmed to provide varying experiences to the user. By varying the timing, sequence, and/or duration of pulses of water delivered through shower heads 653 and/or jets 657 the user experience can be optimized. In this example an array of shower heads and jets are depicted somewhat in line relative to one and other however it will be understood that shower heads and jets may be positioned independently, in a variety of configurations, and in a variety of locations.

The preceding description has been presented only to illustrate and describe examples of the principles described. This description is not intended to be exhaustive or to limit these principles to any precise form disclosed. Many modifications and variations are possible in light of the above teaching.

What is claimed is:

1. A shower head apparatus comprising:
a plurality of shower heads moveably attached to a plurality of rails;
a plurality of robots for positioning the plurality of shower heads along the plurality of rails;
wherein the rails are positioned to allow movement of the shower heads along the rails.

2. The shower head apparatus of claim 1 further comprising:
a shower head deck wherein the shower heads are positioned on the shower head deck above a shower drain deck.

3. The shower head apparatus of claim 1 wherein the plurality of shower heads moveably attached to the plurality of rails are moveably mounted on an enclosure side wall.

4. The shower head apparatus of claim 1 further comprising:
a plurality of coils attached to the shower heads.

5. The shower head apparatus of claim 4 in which the coils supply water.

6. The shower head apparatus of claim 4 in which the coils supply water and power.

7. The shower head apparatus of claim 2 in which the shower heads are configured in pairs such that one robot positions a pair of shower heads.

8. The shower head deck apparatus of claim 1 further comprising a control device, the control device being configured to accept input from a user, the control device being further configured to be in communication with the robot so as to control the shower heads according to the input received from the user.

9. The shower head deck apparatus of claim 8 wherein the control panel is a touch sensitive touch screen.

10. The shower head deck apparatus of claim 8 wherein the control device is responsive to voice control.

11. A shower apparatus comprising:
a shower head deck wherein the shower head deck includes an array of water delivery devices; and,
a shower drain deck including a shower bed wherein the shower head deck is positioned horizontally above the shower drain deck.

12. The shower apparatus of claim 11, wherein the array of water delivery devices includes a plurality of water jets.

13. The shower apparatus of claim 11, further comprising a control panel, the control panel being configured to accept input from a user, the control panel being further configured to control the water delivery devices according to the input received from the user.

14. The shower apparatus of claim 11, further comprising a shower bed positioned between the shower head deck and the shower drain deck.

15. The shower apparatus of claim 11, further comprising a holding tank configured to be filled with water prior to showering use, collect water from the shower drain deck during showering use, and be drained after showering use.

16. The shower apparatus of claim 11, further comprising an upper drain pipe, and a lower drain pipe to drain the shower apparatus after use.

17. A method of showering comprising the steps of:
filling a holding tank with water at a desired temperature;
initiating a desired control program for a plurality of water delivery devices through a user interface;
pumping the water through the plurality of water delivery devices; and
returning the water to the holding tank through one or more drains in a shower bed.

18. The method of showering of claim 17 further comprising the step of:
moving the water delivery devices with a robot according the control program.

19. The method of showering of claim 17 further comprising the step of:
flushing the system with a cleaning solution when the showering apparatus is shut down.

20. The method of showering of claim 18 further comprising the step of:
flushing the system with a cleaning solution when the showering apparatus is shut down.
